(19) United States
(12) Patent Application Publication
(10) Pub. No.: US 2026/0243340 A1
(43) Pub. Date: Aug. 20, 2026

(54) HEAVY DUTY TRANSMISSION ARCHITECTURE DESIGN

(71) Applicant: Eaton Intelligent Power Limited, Dublin 4 (IE)

(72) Inventors: Ajeet K. JHA, Darbhanga (IN); Ashish Mohanrao KANASE, Pune (IN); Satalingayya C. HIREMATH, Belgaum (IN); Sandip Sahadev NEVAREKAR, Pune (IN); Vivekanand R. SOMANNAVAR, Belagavi (IN); Saket BAGAL, Pune (IN); Rajesh Dnyanadev BHOLE, Pune (IN); Dipika AGRAHARI, Kushinagar (IN); Omkar P. KHAIRE, Panvel (IN)

(21) Appl. No.: 18/874,512

(22) PCT Filed: Jun. 13, 2023
(86) PCT No.: PCT/EP2023/025283

§ 371 Date: Dec. 12, 2024

(30) Foreign Application Priority Data
Jun. 13, 2022 (IN) 202211033623

(51) Int. Cl. F16H 57/00; B60K 17/28; F16H 3/097; F16H 63/30

(52) U.S. Cl. CPC F16H 57/0037; B60K 17/28; F16H 3/097; F16H 57/0031; F16H 63/30; F16H 2063/3093

(57) ABSTRACT

A transmission assembly suitable for use with an electric power plant. The transmission assembly includes numerous advantageous features. For example, the transmission assembly can include a robust enclosure with integral mounting features, a bearing assembly which supports an input shaft in a simple support configuration, a thrust mechanism for neutralizing opposing axial loads generated between the input shaft and the main shaft, and an asymmetric clutch assembly.

### RELATED APPLICATION

This application claims priority to Indian Provisional Patent Application Serial Number 202211033623, filed on Jun. 13, 2022, the entirety of which is incorporated by reference herein.

### TECHNICAL FIELD

This disclosure relates to transmissions, and more particularly to heavy duty transmissions suitable for use in electrical vehicle applications.

### BACKGROUND

Transmission assemblies are known. Typically, a transmission assembly receives power via a rotating output shaft from a power plant and outputs power via one or more outputs, with the ability to change the gear ratio between the input and output. In some examples, the power plant is an internal combustion engine while in other examples the power plant is an electric motor. Where the power plant is an electric motor in an electric vehicle (EV) application, a transmission assembly may experience different operating conditions and loads that can decrease the reliability of the transmission assembly. This is particularly the case for buses, trucks, and off-highway, heavy duty vehicles. Motor capabilities such as high speed and high low-end constant torque drive shallow first gear requirements. The combination of high speed, high load and very high-low gear utilizations is unique in EV applications duty cycle in comparison to conventional engine driven transmissions. Accordingly, conventional transmissions would not be suitable in EV applications as traditionally configured. Thus, it is a challenge to design an architecture to meet all these requirements within given space.

### SUMMARY

A transmission assembly can include a twin-countershaft type transmission power train gear assembly having an input shaft assembly and an output shaft assembly, the power train gear assembly having at least one mechanism for changing a gear ratio between the input shaft assembly and the output shaft assembly; an enclosure assembly housing the power train gear assembly, the enclosure assembly including a single-piece enclosure part defining: a nodal mounting structure for mounting the transmission assembly to a vehicle; a mounting arrangement for securing an electronic control unit; and a mounting arrangement for a shifter assembly.

In some examples, the enclosure includes a mounting arrangement for supporting a power take off (PTO) unit.

In some examples, the enclosure assembly includes a modular mounting interface for accepting differently configured adapters.

In some examples, the enclosure assembly further includes a main case secured to an open end of the enclosure.

In some examples, the main case supports a pump assembly and includes at least one lubrication channel.

In some examples, the at least one lubrication channel is cast into the shallow main case.

In some examples, the enclosure is formed from a metal material.

In some examples, the enclosure is formed from aluminum.

In some examples, the PTO unit and the output shaft arrangement are located at a first end of the enclosure.

In some examples, the PTO unit is driven directly by a counter shaft of the power train assembly. In some examples, the PTO unit is driven by a lower counter shaft.

A transmission assembly can include an input shaft assembly including an input shaft extending between a first end and a second end; an output shaft assembly including an output shaft; a power train gear assembly including at least one mechanism for changing a gear ratio between the input shaft assembly and the output shaft assembly, wherein the power train gear assembly includes a head set gear connected directly to the input shaft proximate the first end; and a bearing assembly including a first bearing assembly supporting the head set gear and a second bearing assembly supporting the input shaft proximate the second end, wherein the second bearing assembly and the second end of the input shaft are located within an internal cavity of the output shaft.

In some examples, the head set gear has a first connection interface and a second connection interface with the input shaft.

In some examples, the first connection interface is a splined connection and the second connection interface is a press fit interface.

In some examples, the first bearing assembly is press fit onto the head set gear.

In some examples, a thrust mechanism for neutralizing opposing axial loads generated between the input shaft and the main shaft is provided.

In some examples, a main shaft is provided partially surrounding and coaxially aligned with the input shaft, wherein the thrust mechanism is located between an axial end of the main shaft and an axial surface of one or both of the head set gear and the input shaft. In one characterization, the main shaft floats between the input shaft and the output shaft and is also held in position through the floating main shaft gears between the counter shafts.

In some examples, the thrust mechanism is supported by one or both of the head set gear and the input shaft.

In some examples, the thrust mechanism is located axially between the first bearing assembly and the second bearing assembly.

In some examples, the thrust mechanism is at least partially disposed in a cavity formed between the head set gear and the input shaft.

In some examples, a power take-off (PTO) unit is provided.

A transmission assembly can include an input shaft assembly including an input shaft extending between a first end and a second end; an output shaft assembly including an output shaft; a power train gear assembly including at least one mechanism for changing a gear ratio between the input shaft assembly and the output shaft assembly, wherein the power train gear assembly includes a head set gear connected directly to the input shaft proximate the first end; and a thrust mechanism for neutralizing opposing axial loads generated between the input shaft and the output shaft.

In some examples, the thrust mechanism is supported by one or both of the head set gear and the input shaft.

In some examples, the thrust mechanism is located axially between a first bearing assembly and a second bearing assembly supporting the input shaft.

In some examples, the thrust mechanism is at least partially disposed in a cavity formed between the head set gear and the input shaft.

In some examples, a power take-off (PTO) unit is provided.

In some examples, the thrust mechanism includes a plurality of cylindrical rollers disposed between a pair of thrust washers.

In some examples, the thrust mechanism includes a bearing located about the input shaft.

In some examples, the thrust mechanism includes a conical race adjacent one of the pair of thrust washers and a spherical washer adjacent the conical race.

In some examples, the thrust mechanism includes a wave spring between the head set gear and one of the pair of thrust washers.

In some examples, the input shaft assembly is configured for operation up to 5,000 revolutions per minute.

A transmission assembly can include an input shaft assembly including an input shaft extending between a first end and a second end; an output shaft assembly including an output shaft; and a geartrain assembly for changing a gear ratio between the input shaft and the output shaft, the geartrain assembly including: a head set gear fixed to the input shaft, the head set gear being intermeshed with a first countershaft gear and defining a first internal drive interface; a drive gear intermeshed with a second countershaft gear and defining a second internal drive interface; a main shaft intermeshed with the output shaft, the main shaft defining a first external drive interface; and a clutch assembly including a sleeve member slidably disposed about the main shaft, the sleeve member defining a third internal drive interface engaged with the main shaft first external drive interface, the sleeve member defining a first external gear spline for engagement with the first internal drive interface and a second external gear spline for engagement with the second internal gear, wherein the first external gear spline has a first diameter and the second external gear spline has a second diameter different from the first diameter.

In some examples, the first diameter is smaller than the second diameter.

In some examples, the first external gear spline is spaced from the second external gear spline such to form a channel for accepting a shift yoke.

In some examples, the first external gear spline is at least partially received within head set gear when the sleeve member is in a first position.

In some examples, the second external gear spline is at least partially received within the drive gear when the sleeve member is in a second position.

In some examples, the sleeve member abuts a thrust washer when in the second position.

In some examples, the sleeve member abuts a head set gear surface when in the first position.

In some examples, a thrust mechanism is provided for neutralizing opposing axial loads generated between the input shaft and the main shaft.

In some examples, the thrust mechanism is at least partially received within the sleeve member when the sleeve member is in a first position.

In some examples, the first external gear spline is at least partially received into head set gear when the sleeve member is in the first position.

In some examples, a power take-off (PTO) unit is provided.

Additional objects and advantages will be set forth in part in the description which follows, and in part will be obvious from the description, or may be learned by practice of the teachings presented herein. The objects and advantages will also be realized and attained by means of the elements and combinations particularly pointed out in the appended claims. It is to be understood that both the foregoing general description and the following detailed description are exemplary and explanatory only and are not restrictive of the claimed invention.

### BRIEF DESCRIPTION OF THE DRAWINGS

FIG. 1 is a first perspective view of a transmission assembly having features that are examples of aspects in accordance with the principles of the present disclosure, the transmission assembly being configured for operation with a PTO unit.

FIG. 2 is a second perspective view of the transmission assembly shown in FIG. 1, configured with a PTO unit installed.

FIG. 2A is a second perspective view of the transmission assembly shown in FIG. 1.

FIG. 3 is a perspective exploded view of the transmission assembly shown in FIG. 1.

FIG. 4 is a first perspective view of a rear enclosure part of the transmission assembly shown in FIG. 1.

FIG. 5 is a second perspective view of the enclosure.

FIG. 6 is an end view of an adapter housing of the transmission assembly shown in FIG. 1.

FIG. 7 is a partial cross-sectional side view of the adapter shown in FIG. 6.

FIG. 8 is an end view of a shallow main case of the transmission assembly shown in FIG. 1.

FIG. 9 is a cross-sectional view of the transmission assembly shown in FIG. 1.

FIG. 10 is a partial cross-sectional view of the transmission assembly shown in FIG. 1, illustrating a bearing support of a input shaft of the transmission assembly.

FIG. 11 is a partial cross-sectional view of the transmission assembly shown in FIG. 1, schematically depicting the transmission of a PTO load.

FIG. 12 is a partial cross-sectional view of the transmission assembly shown in FIG. 1, schematically depicting radial and moment loading of the input shaft and an attached head set gear during the PTO loading condition.

FIG. 13 is a partial side cross-sectional view of the transmission assembly shown in FIG. 1, illustrating a connection between the head set gear and the input shaft.

FIG. 14 is a partial end cross-sectional view of the transmission assembly shown in FIG. 1, illustrating a connection between the head set gear and the input shaft.

FIG. 15 is a partial side cross-sectional view of the transmission assembly shown in FIG. 1, illustrating a thrust mechanism, alignment aspects, and operational forces.

FIG. 16 is a partial side cross-sectional view of the transmission assembly shown in FIG. 1, further illustrating the thrust mechanism.

FIG. 17 is a partial side cross-sectional view of the transmission assembly shown in FIG. 1, further illustrating the thrust mechanism.

FIG. 18 is a partial side cross-sectional view of the transmission assembly shown in FIG. 1, illustrating normal operation torque and moment forces.

FIG. 19 is a partial side cross-sectional view of the transmission assembly shown in FIG. 1, illustrating PTO operation torque and moment forces.

FIG. 20 is a partial side cross-sectional view of the transmission assembly shown in FIG. 1, further illustrating a main shaft abutment surface for the main shaft assembly.

FIG. 21 is a partial side cross-sectional view of the transmission assembly shown in FIG. 1, illustrating thrust forces generated during a drive condition.

FIG. 22 is a partial side cross-sectional view of the transmission assembly shown in FIG. 1, illustrating thrust forces generated during a coast condition.

FIG. 23 is a partial side cross-sectional view of the transmission assembly shown in FIG. 1, illustrating a sliding clutch assembly of the transmission assembly.

FIG. 24 is a perspective view of a sliding clutch of the assembly shown in FIG. 23.

FIG. 25 is a cross-sectional side view of the sliding clutch shown in FIG. 24.

FIG. 26 is a partial end view of the sliding clutch shown in FIG. 24.

FIG. 27 is a partial side cross-sectional view of the sliding clutch shown in FIG. 24.

FIG. 28 is a cross-sectional end view of the sliding clutch shown in FIG. 24.

FIG. 29 is a perspective view of a thrust washer of the transmission assembly shown in FIG. 1.

FIG. 30 is a partial view of the sliding clutch shown in FIG. 24, illustrating a back taper angle.

FIG. 31 is a partial cross-sectional view of the head set gear shown in FIG. 23.

FIG. 32 is a cross-sectional end view of the head set gear shown in FIG. 31.

FIG. 33 is a partial cross-sectional side view of the transmission assembly shown in FIG. 1, illustrating a maximum thrust area between the sliding sleeve and thrust washer.

FIG. 34 is a partial cross-sectional side view of the transmission assembly shown in FIG. 1, illustrating clearances with the thrust assembly.

FIG. 35 is a perspective view of the transmission assembly shown in FIG. 1 with the enclosure housing shown as transparent to illustrate a lubrication conveyance path.

FIG. 36 is a second perspective view of the transmission assembly shown in FIG. 35.

FIG. 37 is a partial perspective view of the transmission assembly shown in FIG. 35.

FIG. 38 is a cross-sectional view of a portion of the transmission assembly shown in FIG. 37.

FIG. 39 is a cross-sectional view of a portion of the transmission assembly shown in FIG. 37.

FIG. 40 is a cross-sectional view of a portion of the transmission assembly shown in FIG. 1, further illustrating lubrication conveyance pathways.

FIG. 40A is a cross-sectional view of a portion of the transmission assembly shown in FIG. 1, further illustrating lubrication conveyance pathways.

FIG. 41 is a cross-sectional view of a portion of the transmission assembly shown in FIG. 1, and as indicated at FIGS. 36 and 42, further illustrating lubrication conveyance path.

FIG. 42 is a cross-sectional view of the pump assembly of the transmission assembly of FIG. 1.

FIG. 43 is a partial exploded perspective view of a portion of the transmission assembly of FIG. 1, showing enclosure and sealing features of the assembly.

### DETAILED DESCRIPTION

This disclosure is related to transmission assemblies for use in multiple applications.

### Transmission Assembly 10 General Description

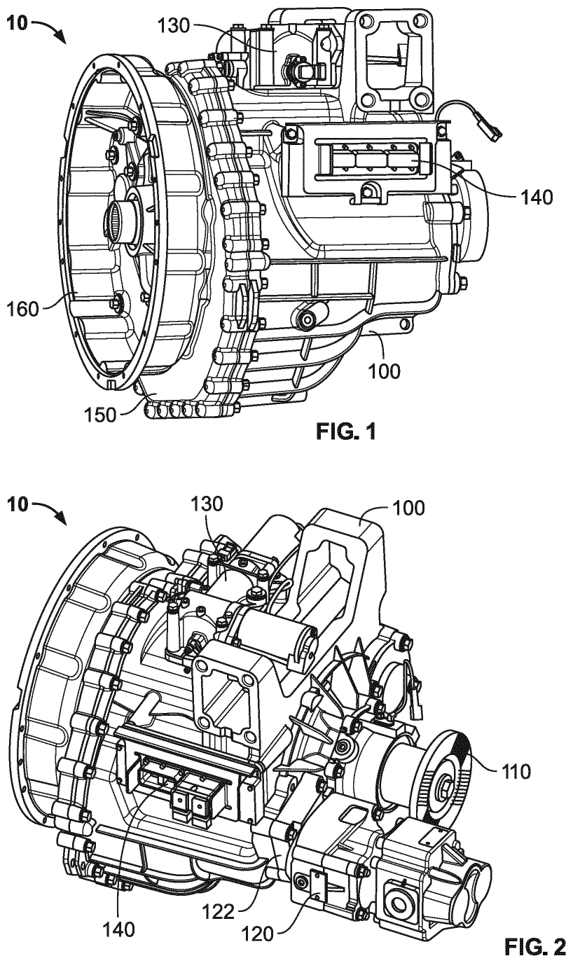

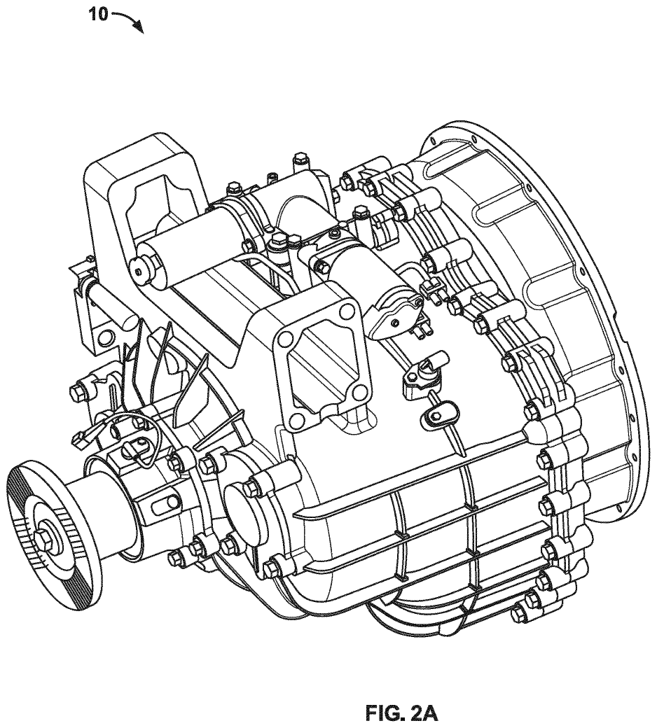

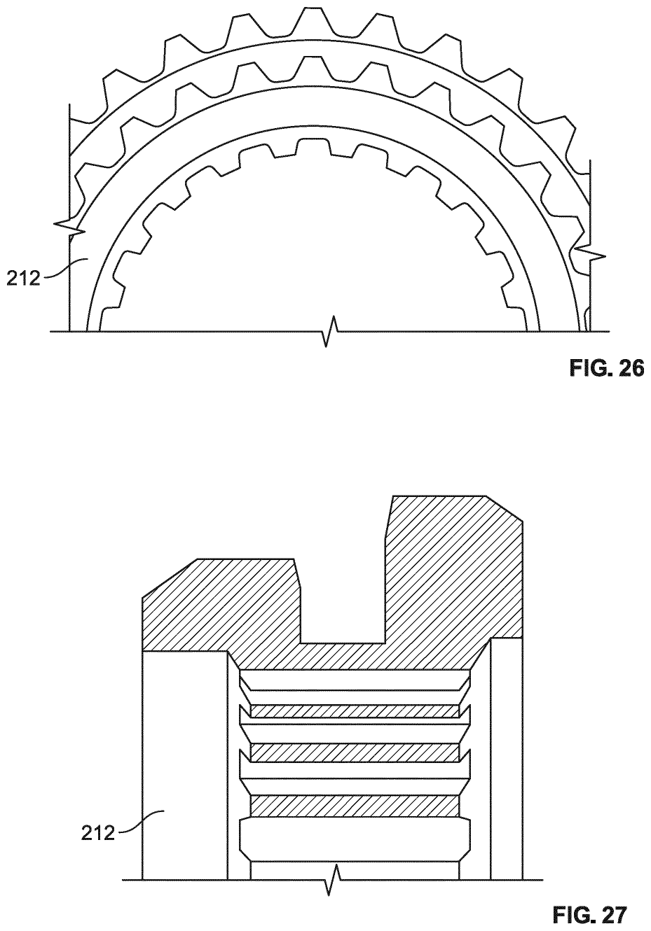

Referring to FIGS. 1-34, an example transmission assembly 10 of the present disclosure is illustrated. In the examples presented, and as most easily viewed at FIGS. 1-3 and 9, the transmission assembly 10 is configured with a twin counter shaft design.

In one aspect, the transmission assembly 10 is provided with an enclosure assembly 100 for housing the internal components of the transmission assembly 10 and for supporting external components secured to the housing 100. As shown, the enclosure assembly 100 externally supports a main power output assembly 110 and a power take-off unit (PTO) 120, a shifter assembly 130, an electronic controller 140 for controlling the shifter assembly 130 and for communicating with the vehicle (e.g. via CAN BUS), and I/P sensor 142. At an end opposite the main power output assembly 110 and PTO 120, a shallow main case 150 is secured to the enclosure assembly 100 with an adapter housing 160 being secured to the shallow main case.

Internally, the transmission assembly is configured with a power train 165 including an input shaft assembly 170, a main shaft assembly 180 extending over the input shaft 170, and an output shaft assembly 190 splined to the main shaft assembly 180. In one aspect, the assemblies 170, 180, and 190 are coaxially aligned together. A head set gear 200 is mounted to the input shaft assembly 170 while first and second sliding clutch assemblies 210, 220 are slidingly splined to the main shaft assembly 180. Progressively larger drive gear assemblies 230, 240, and 250 are also shown as being provided and are coaxially aligned with the main shaft assembly 180. The transmission assembly 10 further includes a pair of counter shafts 260, 270 disposed on opposite sides of the shaft assemblies 170, 180, 190 having progressively smaller associated gear or gear assemblies 262/272, 264/274, 266/276, 268/278. In the example shown, gears 262/272 and 264/274 are separately formed from and mounted to their respective shafts 260, 270 while gears 266/276, 268/278 are integrally formed with their respective shafts 260, 270. As configured, gear assemblies 262/272 are meshed with the head set gear assembly 200, gear assemblies 264/274 are meshed with the drive gear 230, gear assemblies 266/276 are meshed with the drive gear 240, and the gear assemblies 268/278 are meshed with the drive gear 250. In the example presented, the disclosed gears are helical gears in which the gears are provided with teeth cut an oblique angle to the rotational axis of the gear such that a line of contact between intermeshed gears is also oblique or non-parallel to the rotational axis. It is noted that the clutch assemblies 210, 220 are provided with externally facing straight teeth or splines that interact with correspondingly straight internally facing teeth or splines on the head set gear 200 and drive gears 230, 240, 250.

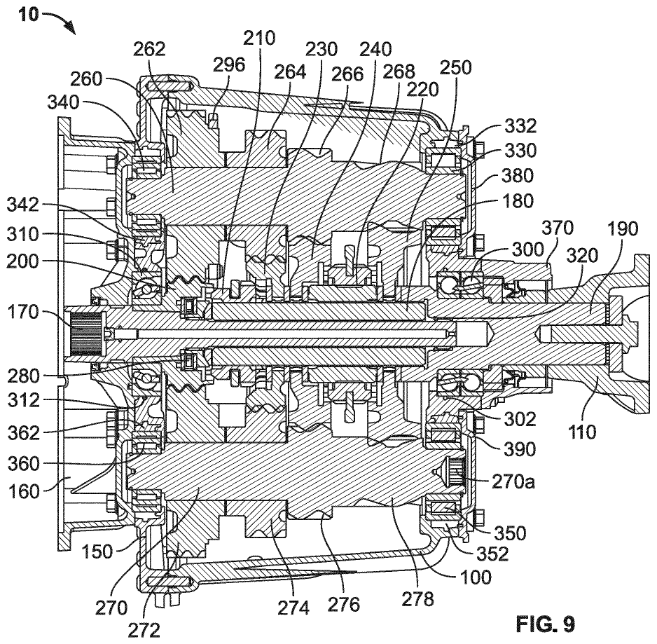

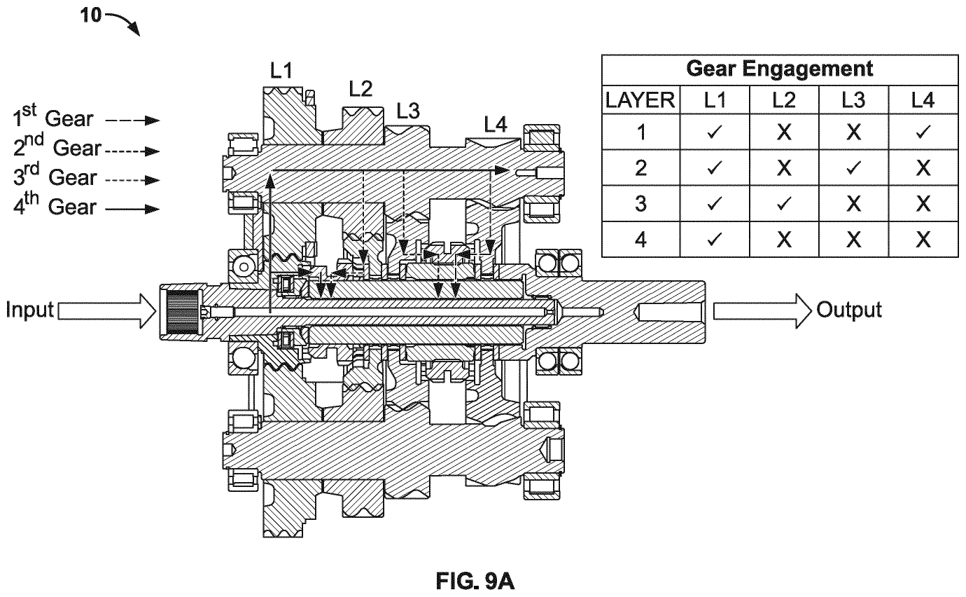

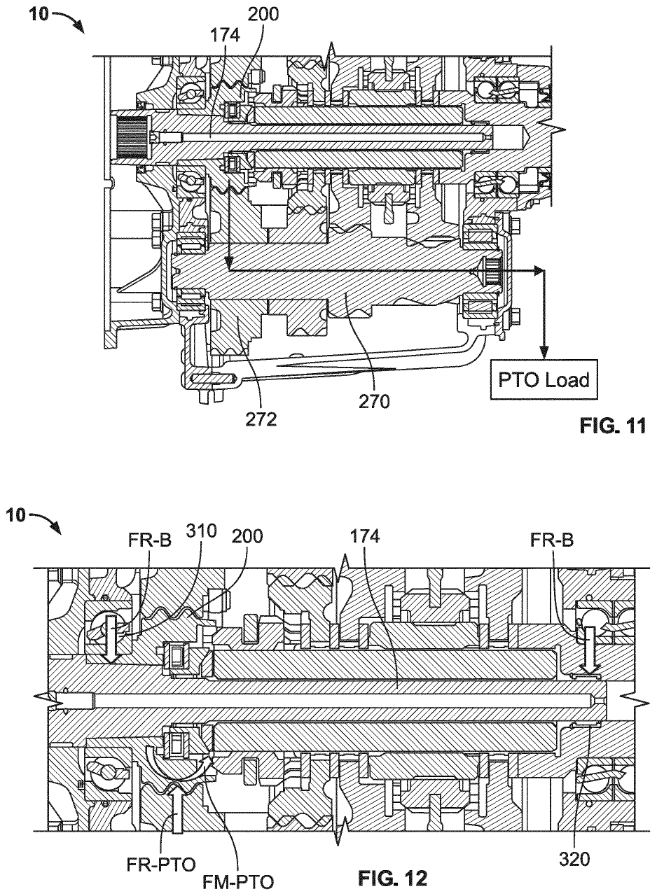

In operation, the shifter assembly 130 operates a shift shaft assembly 135 to selectively operate the first and second sliding clutch assemblies 210, 220 such that the first clutch assembly 210 engages the main shaft assembly 180 with the head set gear assembly 200 or the drive gear 230, to respectively achieve third and fourth gearing ratios between the input shaft assembly 170 and output shaft assembly 190, or such that the second clutch assembly 220 engages the main shaft assembly 180 with the drive gear 240 or the drive gear 250 to respectively achieve first and second gearing ratios between the input shaft assembly 170 and output shaft assembly 190. In the configuration shown, the counter shaft 270 provides power to the PTO 120 via splined connection 270a which receives rotational power at the gear ratio set between the head set gear 200 and the gear assembly 262. FIG. 9A schematically depicts the four different gears or gear ratios the transmission assembly 10 can be operated among. FIG. 11 schematically shows the power transmission from the input shaft 170 to the PTO load while FIG. 12 shows the resulting loading forces.

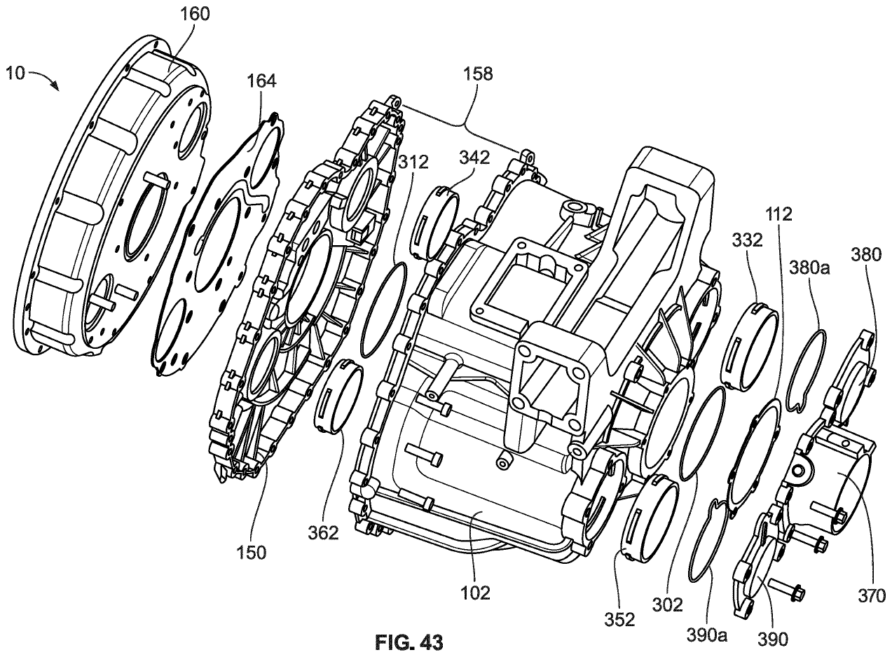

The transmission assembly 10 is further shown as including an internal pump assembly 290, driven by the power train, for circulating lubricating fluid throughout the assembly. The transmission assembly 10 is also shown as including various bearing assemblies for supporting the shaft assemblies. For example, bearing assembly 300 is shown as supporting the output shaft assembly 190, bearing assembly 310 is shown as supporting the head set gear 200 and input shaft assembly 170, bearing assembly 320 is shown as supporting the input shaft assembly 170 within the output shaft assembly 190, bearing assemblies 330, 340 are shown as supporting the counter shaft 260, and bearing assemblies 350, 360 are shown as supporting the counter shaft 270. In the example shown, the bearing assemblies are shown as radial bearings, such as radial ball bearings and radial needle bearings. Other bearing types are possible. With reference to FIGS. 9 and 43, it can be seen that anti-rotation features 332, 342, 352, 362 are respectively provided for receiving bearing assemblies 330, 340, 350, 360. The anti-rotation features 332, 352 are received into openings in the rear enclosure part 102 while anti-rotation features 342, 362 are received into openings in the shallow main case 150. In one example, the anti-rotation features are formed from a different material than the enclosure material and provide a more dimensionally stable structure for supporting the bearings 330, 340, 350, 360. In one example, the rear enclosure part 102 and shallow main case 150 are formed from aluminum, the anti-rotation features 332, 342, 352, 362 are formed from cast-iron, and the bearings assemblies 330, 340, 350, 360 are formed from a steel material. With such an arrangement, the anti-rotation features are formed from a material with a lower coefficient of thermal expansion in comparison to the material of the enclosure part and main case, thereby resulting in an improved mounting of the bearing assemblies which reduces or eliminates the problem of bearing creep at elevated temperatures during operating conditions. As shown, the anti-rotation features 332, 342, 352, 362 are provided with rib structures that interact with rib structures formed in the rear enclosure part 102 and shallow main case 150 such that when the anti-rotation features are inserted into the rear enclosure part 102 and shallow main case 150, the anti-rotation features are unable to rotate relative to the enclosure. Anti-rotation features 302 and 312 may also be provided for bearings 300 and 310. In the example shown, the anti-rotation features 302, 312 are provided in the form of an O-ring disposed between the enclosure opening and the bearing assemblies 300, 310.

The transmission assembly is further shown as including cover assemblies 370, 380, and 390 for covering openings in the rear enclosure part 102 associated with the output shaft 190 and counter shafts 260, 270, respectively.

In one aspect, a thrust mechanism 280 is provided between the input shaft assembly 170 and the main shaft assembly 180. The thrust mechanism 280 is described in more detail in a later section of the disclosure.

### Enclosure Sub-System Architecture

Referring to FIGS. 1-8, the enclosure sub-system architecture is now described in more detail. In one aspect, the enclosure assembly 100 can be characterized as including a single main rear enclosure part 102 to which a shallow main case 150 is attached, and can also be characterized as additionally including the adapter housing 160. The enclosure assembly 100 can also be characterized as including cover assemblies 370, 380, 390.

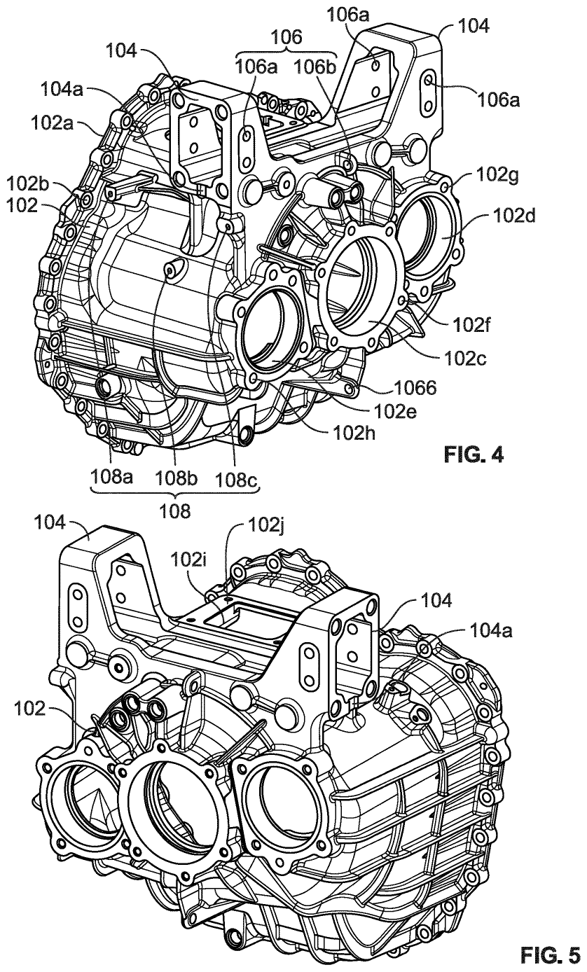

Referring to FIGS. 4 and 5, the rear enclosure part 102 is shown in isolation. In one aspect, the architecture of the enclosure assembly 100 is configured for a twin counter shaft design and is provided with sufficient structural integrity and thorough NVH aspects (noise, vibration, harshness) to be used in a 2600 Nm torque capacity, or more, electrical vehicle application. In such a configuration, the rear enclosure part 102 is compatible with adapter housings 160 provided with SAE #1 and #2 configurations for housing a respective flywheel and providing a bolting arrangement for securement to the vehicle and/or powerplant. In one aspect, the rear enclosure part 102 is provided with a nominal or average wall thickness of 5.5 mm and strength-enhancing ribs which aid in giving the rear enclosure part 102, the aforementioned structural characteristics. The rear enclosure part 102 is also provided with a curved design with smooth transitions between surfaces to eliminate or reduce the accumulation of, for example, debris, dust, ice, and water. In one example, the rear enclosure part 102 is formed from a metal material, such as a low-pressure die cast A-356 aluminum material.

The enclosure assembly 100 is provided with many other advantageous features. For example, the enclosure assembly 100 is provided with a nodal mounting arrangement; a mounting arrangement for the electronic control unit (ECU) 140; a lubrication worm track; a lubrication channel, a rear mount PTO interface design; and a design to meet a pass-by noise level target of 79 dBA. Further, the disclose design enhances ease of assembly with easy accessibility of the power train components, shift system, and the pump assembly and enables a total system weight of less than 200 kg. The disclosed design also includes mounting position configurations derived from SAE nodal mount and OEM requirements. Additionally, sealing joint interface characteristics are provided to account for variation of heat generated due to gear mesh. Yet another feature is a restraining or anti-rotation mechanism between housing and bearing to avoid bearing creep.

In contrast to conventional enclosure assembly configurations, the disclosed enclosure assembly 100 has many advantages. For example, the disclosed design provides for an integrated cover for the front counter shafts and input shafts-limited space accessibility due to SAE #2; a flexible adapter housing design in which multiple different motor configurations can be used, including non-standard motor interfaces, input shaft lengths, and spline configurations; the adaptability of an the adapter housing between SAE #2 and SAE #1 flanges; a lubrication worm track which avoids the requirement of additional seal joint (inside pump mounting); easy of assembly (accessibility) of power train components, shift system and pump assembly; accommodation of power train architecture with higher CD of 155 mm; a nodal odal Mount arrangement as per SAE J1134; provision for a rear offset PTO; and ease of service at OEM end.

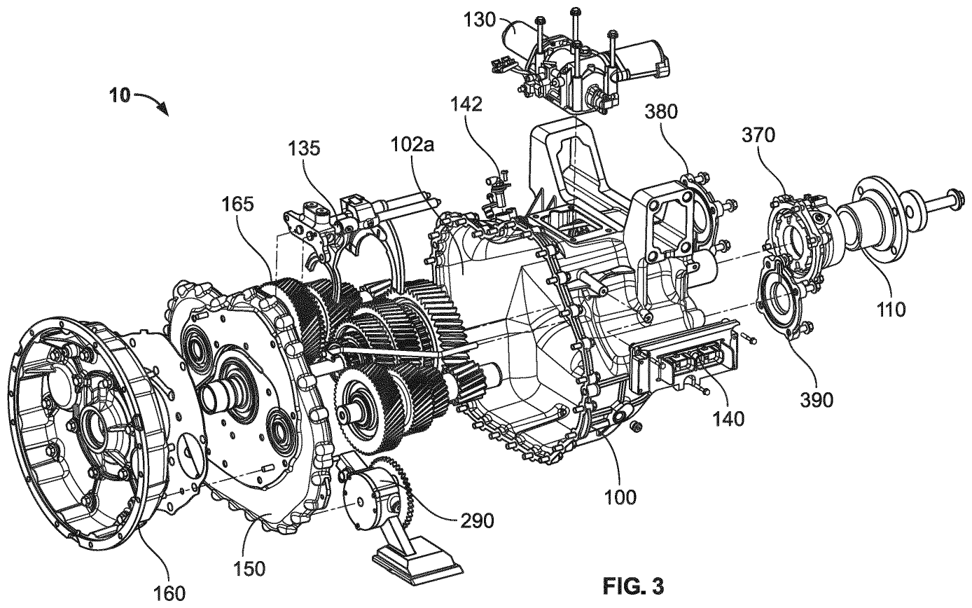

Referring to FIGS. 3-5, it can be seen that the rear enclosure part 102 is provided with a first opening 102a and bolt hole arrangement 102b for securement to the shallow main case 150 and is provided with openings 102c, 102d, 102e that are coaxially aligned with the shaft assemblies 170, 180, 190. Bolt hole arrangements 102f, 102g, 102h are provided at these openings such that cover assemblies 370, 380, 390 can be secured to the rear enclosure part 102, in addition to the main power output assembly 110 and PTO 120. The rear enclosure part 102 is additionally provided with a top opening 102i and bolt hole arrangement 102j for receiving and securing the shifter assembly 130. In one aspect, the rear enclosure part 102 is also provided with a direct mount arrangement 108, with individual mounting points 108a, 108b, 108c, such that the ECU 140 can be directly mounted to the rear enclosure part 102. By providing a direct mount arrangement in the configuration shown, reliability, accessibility of the ECU, and NVH performance are improved while costs are decreased by avoiding the need for a separate mounting bracket. The rear enclosure part 102 may be provided with further porting and mounting features for supporting other various features of the transmission assembly 10.

In one aspect, the rear enclosure part 102 is provided with a pair of oppositely facing nodal mount flange structures 104 integrally formed with the rear enclosure part 102. In one aspect, the nodal mount flange structures 104 are SAE J1134 nodal mount flanges with a 4×M20 bolt pattern on both sides. The nodal mount flange structures 104 provide rigid support to the transmission assembly 10 and are connected to the vehicle chassis via brackets and rubber stiffeners. The nodal mount flange structures 104 are also provided with water drain features 104a to aid in draining water and/or ice accumulating on the top of the transmission assembly 10.

In one aspect, the enclosure is provided with a lifting arrangement 106 with sub-arrangements 106a, 106b. The sub-arrangements 106a are configured as 106b can be configured as through-holes, for receiving pins or hooks, or as threaded openings to receive bolts or other types of threaded members. All or portions of the lifting arrangement 106 can also be utilized to provide rigid support for transmission wiring harnesses to avoid loosening due to vibrations.

As discussed previously, the PTO 120 can be mounted to the rear enclosure part 102 via mounting arrangement 102h. The provision of the PTO 120 enables the transmission assembly 10 to run auxiliary applications. In the example shown, an insert 122 is provided between the rear enclosure part 102 and the PTO 120 to facilitate mounting of the PTO 120. By providing a direct mounting location for the PTO to the rear enclosure part 102, substantial space savings can result. Accordingly, the disclosed design can be configured to more easily meet OEM requirements.

### Lubrication Circuit

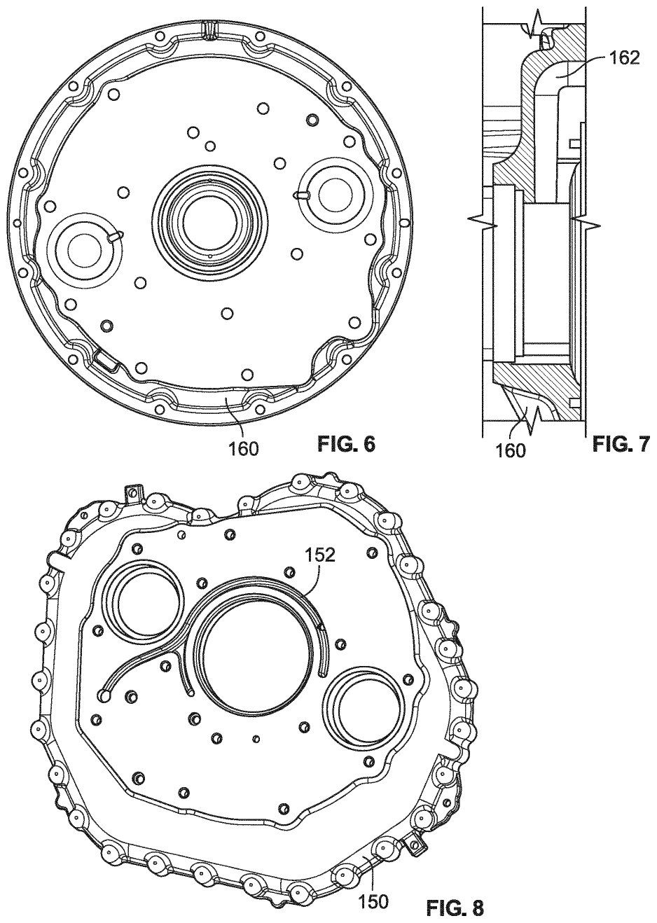

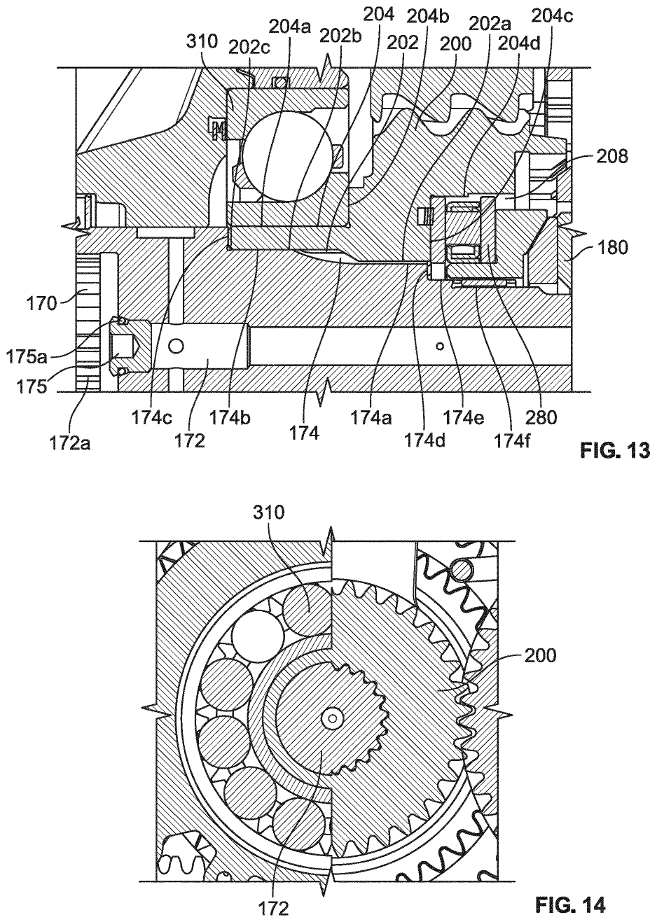

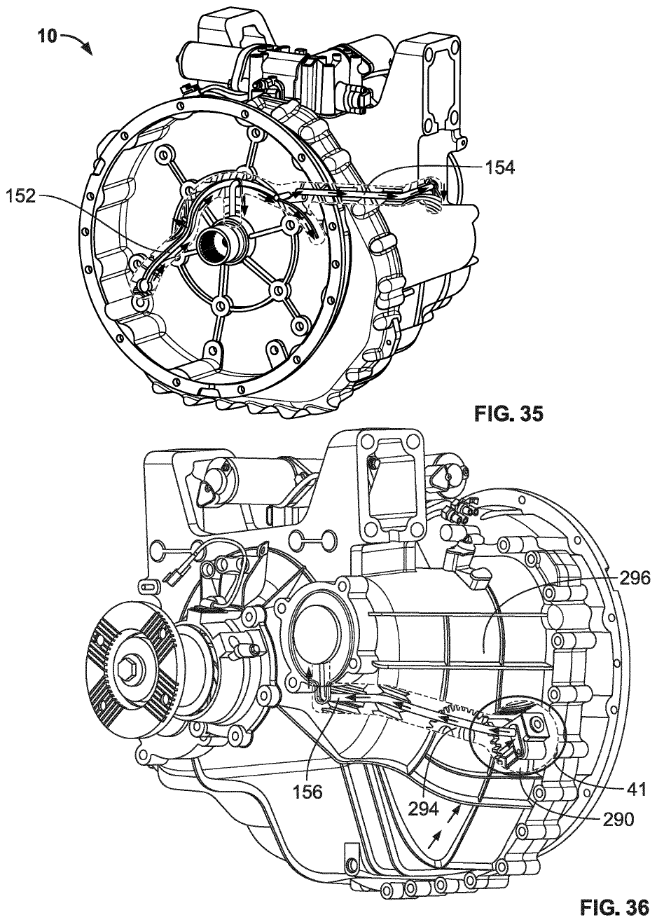

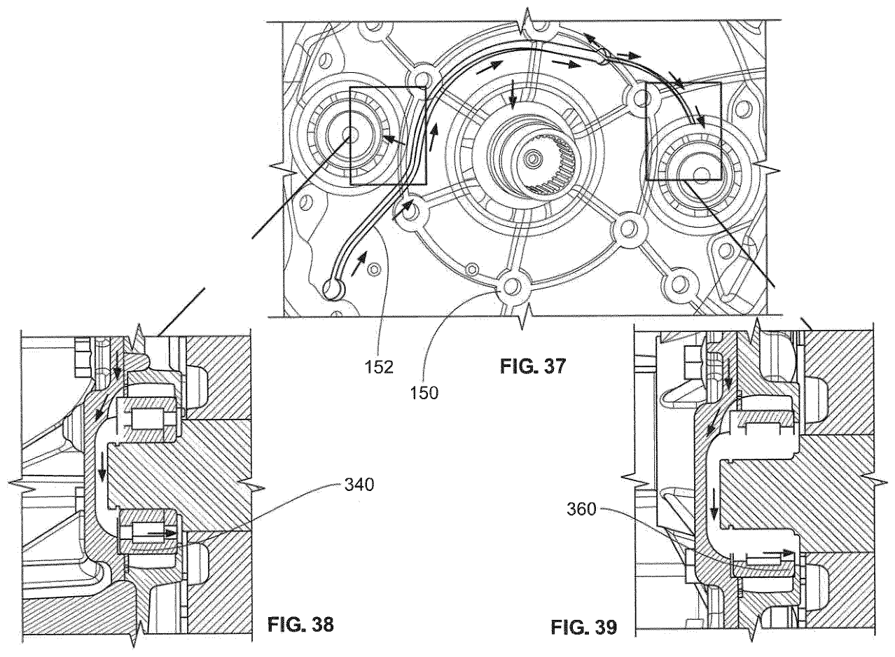

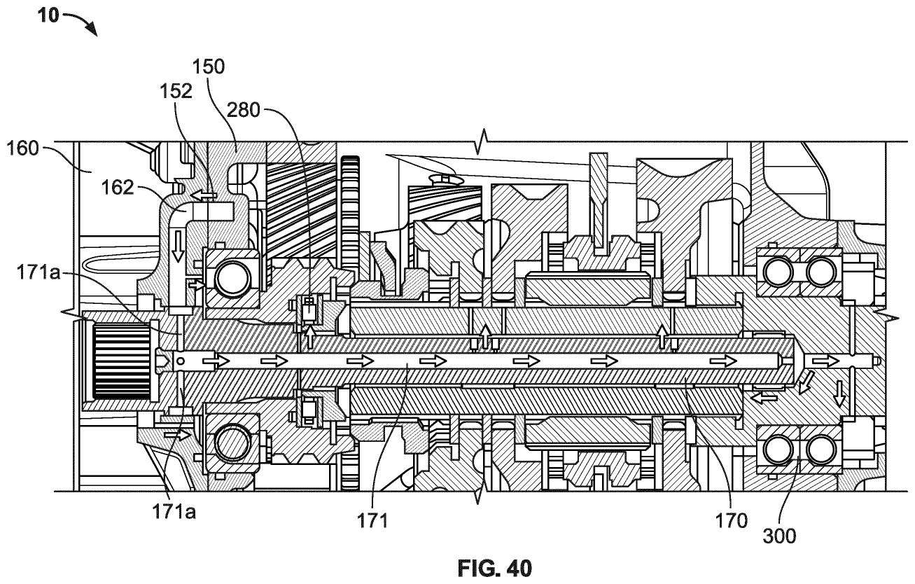

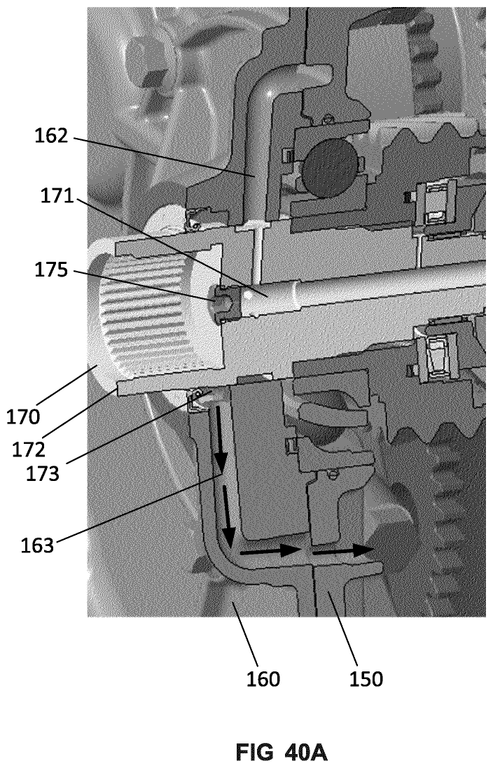

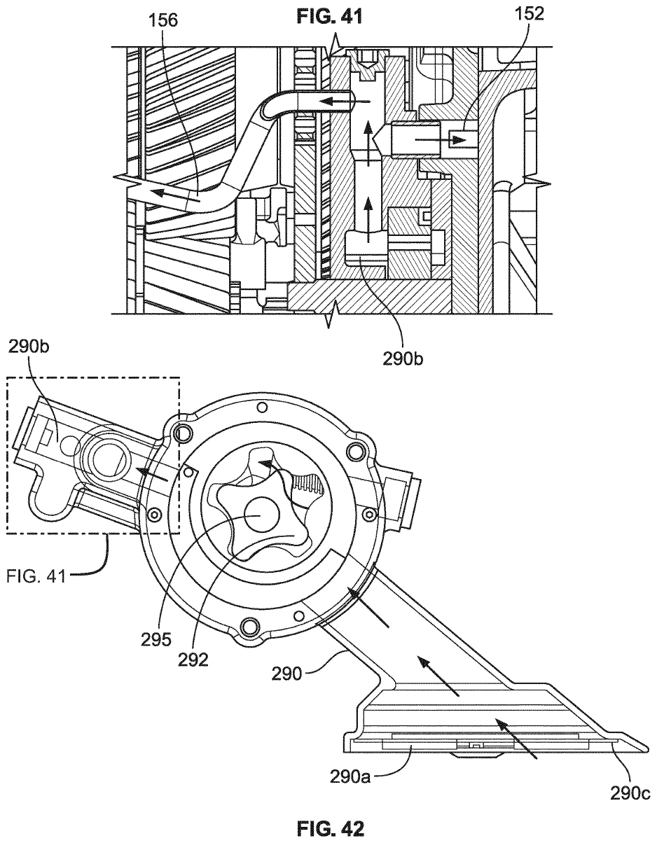

With reference to FIGS. 6 to 8 and 35 to 42, features relating to the lubrication circuit are further detailed. As indicated previously, the transmission assembly 10 includes an internal pump assembly 290 which is supported in and by the shallow main case 150. In one aspect, the pump assembly 290 includes an inlet 290a and an outlet 290b. The pump assembly also includes a gerotor rotor 292 for generating pressure and flow from the inlet 290a to the outlet 290b. In one aspect, the inlet 290a is part of a support base 290c attached to the shallow main case 150 and is surrounded by the bottom portion of the rear enclosure part 102, which defines a sump area. Accordingly, the pump assembly 290 will draw lubricant pooled or collected at the bottom of the rear enclosure part 102 into the inlet 290a and deliver the fluid to the outlet 290b. In one aspect, the pump assembly 290 includes a gear 294 connected to the gerotor rotor 292 via a shaft 295. The gear 294 is driven by a drive gear 296 which is pressed onto or otherwise attached to the gear 262 associated with countershaft 260. Accordingly, the impeller rotational speed is a fixed ratio with respect to the input shaft rotational speed. From the pump assembly 290, lubricant flows from the outlet 290b into a worm track 152, shown as being cast into the shallow main case 150, and into a lower lube tube 156. In one aspect, tube 156 is supported at a front end into the pump housing and at a rear end into the rear case and directs oil to the rear bearing cover channel port to assist in lubricating of the counter shaft rear bearing 330. The worm track 152 provides lubricant flow paths to the front bearing assemblies 310, 340, 360 and connects to an upper lube tube 154 where lubricant is then delivered to the rear bearing assembly 330 after delivering lubricant the gear mesh points between the gears via intermediate ports. In one aspect, tube 154 is connected into the shallow main case 150 and is supported by a feature in the rear case directing the lubricant to the lower CS rear bearing 350 through the bearing cover 390. The lower lube tube 156 delivers lubricant to the bearing 350 after delivering lubricant the gear mesh points between the gears via intermediate ports. Lubricant also flows through an interior passageway 171 in the input shaft 172, via paths 171a in the input shaft 172 and a lubrication path 162 defined in the adapter plate 160, and then to the thrust mechanism 280, thrust washers, and bearing assemblies 320, 300 before returning to the oil sump portion of the rear enclosure part 102. The adapter plate 160 is also configured with a port to relieve lubricant to the sump. Referring to FIG. 40A, the lubrication circuit is also shown as including a relief passageway 163 in the adapter plate 160 that drains surplus oil back the sump while reducing back pressure on the front seal 173 associated with the input shaft 172. FIG. 40A also shows a plug 175 provided at one end of the passageway 171. Plug 175 is shown in greater detail at FIG. 13, where it can be seen that an O-ring seal 175a is also provided in a groove of the plug 175 to form a seal between passageway 171 and the plug 175.

### Input Shaft and Head Set Gear

Referring to FIGS. 9-15, aspects of the input shaft and head set gear assemblies are now described in more detail. The misalignment of a prime-mover's drive shaft with respect to the transmission centerline is a very critical factor in defining the reliability of transmissions. Additionally, unbalanced and misaligning forces due to PTO and pump operation makes transmission input shaft design further challenging for the durability of the transmissions. The robust input shaft design disclosed herein plays a decisive role in minimizing the risks associated with such misalignments. The disclosed input shaft assembly design with a splined a head set drive gear and simply supported bearings at the rear end of transmissions creates a robust architecture to reduce radial displacement of the head set drive gear and thus enhances reliability. By supporting the input shaft the ends with two bearing assemblies and with increased overlap of the head set bearing and input shaft, required stiffness is provided to the system in comparison to conventional cantilever type input shaft designs.

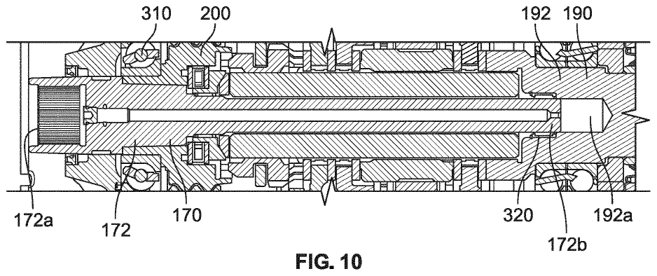

Referring to FIG. 10, it can be seen that the input shaft assembly 170 includes an input shaft 172 extending between a first end 172a and a second end 172b. the first end 172a is provided with an interface, shown here as internally facing splines, for engaging with the power plant or prime mover. The second end 172b extends into a cavity 192a of an output shaft 192 of the output shaft assembly 190 to result in a compact shaft arrangement. As mentioned previously, the head set gear 200 is fixedly mounted to the input shaft 172 and supported by a bearing assembly 310 while the second end 172b of the shaft 172 is supported by the bearing assembly 320. As a result, the input shaft 172 is provided with a simply supported configuration. This kind of support helps to distributes the radial forces uniformly over a longer shaft span and thus restricts shaft radial displacement and provides better alignment with respect to Gearbox center.

In one aspect, the head set gear 200 is secured to the input shaft 172 with an arrangement that ensures a perfectly matched center between the input shaft 172 and the head set gear 200 while ensuring a reliable and high strength connection for optimum torque transfer. In the example shown, the input shaft 172 is provided with an outer surface 174 defining a splined section 174a, a larger diameter smooth collar section 174b, and a shoulder 174c extending from the collar section. The head set gear 200 is provided with an inner surface 202 defining a splined section 202a, a collar section 202b, and an end surface 202c. the collar sections 174b, 202b are configured such that the head set gear 200 must be press fit onto the input shaft 172, thus ensuring complete coaxial alignment of the two components. The shoulder 174c and the end surface 202c provide a stop surface for the head set gear 200 such that full engagement between the components can be ensured and verified. The head set gear 200 and input shaft 172 are further secured together via interaction between the splined section 174a on the input shaft 172 and the splined section 202a on the head set gear 200. The splined connection ensures that full torque transfer from the input shaft 172 to the head set gear 200 can be accomplished. Together, these combined features provide for a high strength, fully aligned arrangement. Such an arrangement has the further benefit of ensuring equal torque transfer to each of the countershaft assemblies 260, 270.

In one aspect, the head set gear 200 is further provided with an outer surface 204 defining a radial surface 204a and axial surface 204b providing for respective press-fit and stop surfaces for the bearing assembly 310. The resulting assembly of the bearing assembly 310, head set gear 200, and input shaft 172 in addition to the input shaft 172 being supported at the opposite end by bearing assembly 320 results in a robust configuration with increased stiffness able to handle the various loads within the assembly. For example, with reference to FIGS. 11 and 12, the bearing assemblies 310 and 320 are advantageously able to provide sufficient radial support forces (FR-B) to accommodate the necessarily resulting unbalanced radial (FR-PTO) and moment/torque (FM-PTO) loads (PTO Load) caused by operation of the PTO 120 via countershaft 270.

In one aspect, the head set gear 200 and input shaft 172 together define a cavity 208 for receiving the thrust mechanism 280 therebetween. The cavity 208 can be characterized as being defined by surfaces 174d, 174e, and 174f on the input shaft 172 and by surfaces 204c, 204d on the head set gear 200. By providing the cavity 208, a compact assembly results in which the thrust mechanism 280 is provided without resulting in an overall increase in the axial length of the assembly.

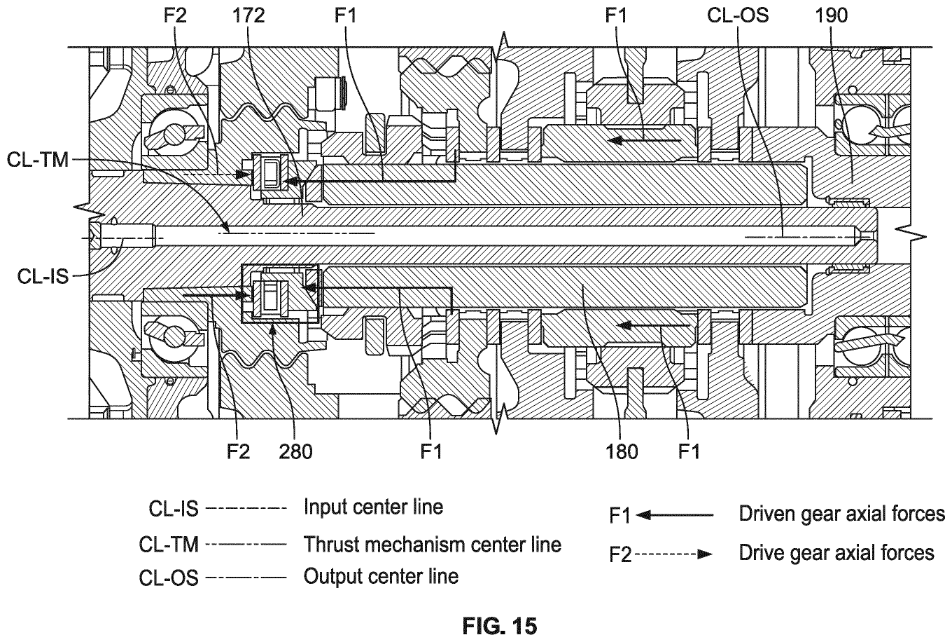

Referring to FIG. 15, it can be seen that the thrust mechanism 280 is axially located between the head set gear 200 and an axial end of the main shaft assembly 180, and that the centerlines of the thrust mechanism 280, input shaft 172, and output shaft assembly 190 are coaxially aligned. The above-noted simple support provided to the input shaft 172 aids in ensuring this alignment. In operation, driven gear axial forces F1 act on a first side of the thrust mechanism in a first direction (axially in a direction from the output shaft assembly 190 towards the thrust mechanism 280) while drive gear axial forces F2 act on a second opposite side of the thrust mechanism in an opposite second direction. Accordingly, the thrust mechanism 280 functions to neutralize the convergence of the resulting opposing axial thrust loads during operation. The thrust mechanism is described further in the next section. In the coast condition, thrust forces from thrust mechanism 280 are transmitted to a thrust washer 289a via a shoulder or button 180a on the main shaft assembly 180, then through gear 230, thrust washer 289b, gear 240, clutch assembly 220, thrust washer 289d, gear 250, thrust washer 289e, and to the output shaft assembly 190.

### Thrust Mechanism

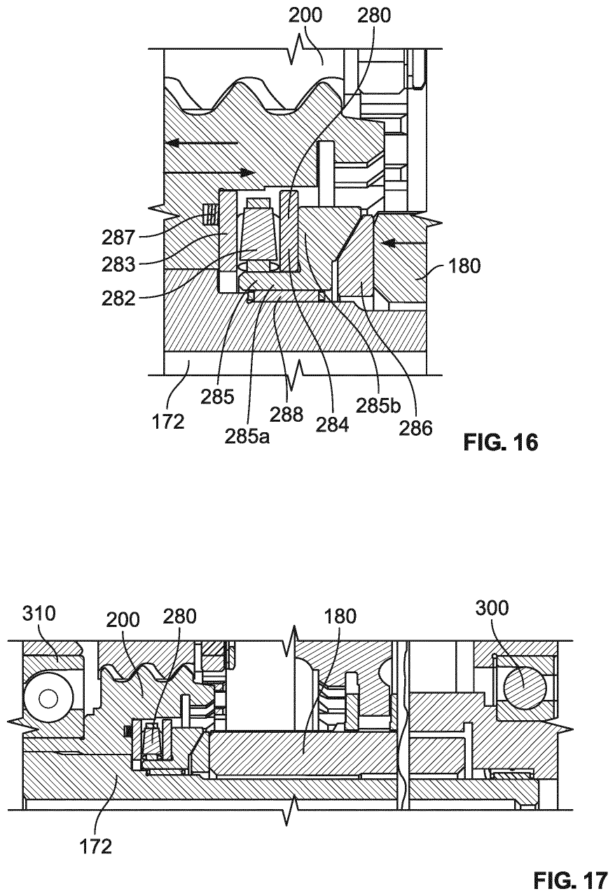

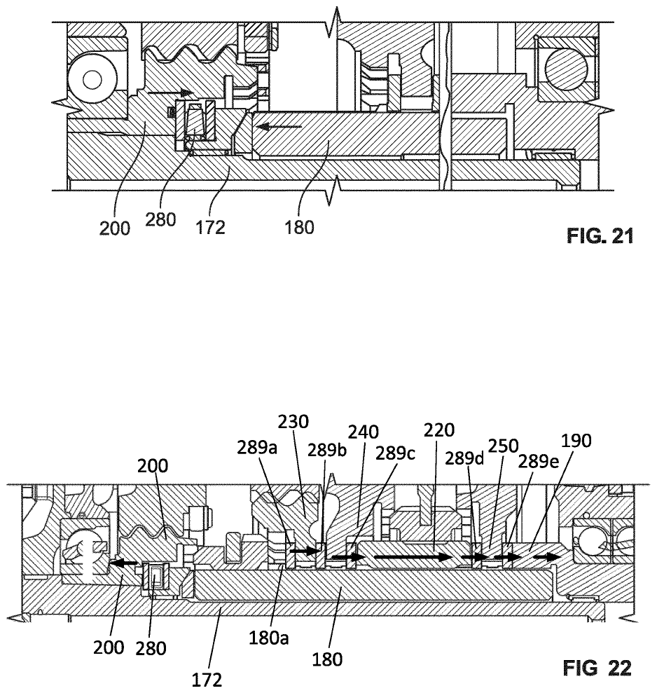

Referring to FIGS. 16-22, aspects of the thrust mechanism are now described in more detail. In operation, active gears on the input shaft assembly 170 and the main shaft assembly 180 generate equal opposite axial thrust (e.g. ~30 kN) during drive and coast conditions due to constant lead gear design. In electric vehicle applications, significant hours of operation in the coast condition occur, in contrast to vehicles using an internal combustion engine. This increase in coast time creates challenge to meet support bearings reliability if they are designed to take thrust loads under both drive and coast conditions. With reference to FIG. 21, a drive condition is illustrated in which axial thrust forces are generated by head set gear 200 and any of main shaft gears. In this condition, these forces are equal and transmitted towards each other and are grounded at rollers of the thrust mechanism 280 so as to nullify each other within the system. The thrust mechanism 280 is loaded in this condition and is designed for sufficient thrust capacity. With reference to FIG. 22, a coast condition is illustrated in which the thrust forces generated by the head set gear 200 and any main shaft gears are equal and transmitted opposite to each other. The support bearings of the thrust mechanism 280 are designed to withstand thrust forces during this condition. In this condition, the thrust rollers bearing is unloaded and a wave spring, discussed below, provides sufficient preload to avoid any chances of rollers skidding.

Additionally, as the disclosed architecture is designed for fullest gear reduction within a single box, support bearings load is increased significantly compared to conventional architectures (e.g. where, reduction is distributed between two boxes). The inclusion of the thrust mechanism 280, as stated above, nullifies drive thrust forces within the system and therefore allows support bearings to be designed for coast loading only which ensures support bearings to meet their reliability within given envelop. Further, electrical vehicle applications have very high differential speed (4200 RPM approx.) between the input and output sides due to the use of an electric motor as the prime mover. The disclosed thrust mechanism 280 advantageously provides a rolling contact interface operable at high relative speed with minimal frictional losses compared to conventional spigot or journal bearing arrangement for thrust forces.

To achieve the above-noted advantages, the thrust mechanism 280 is configured with a plurality of cylindrical thrust rollers 282 disposed between a pair of thrust washers 283, 284. A conical race 285 is provided adjacent the thrust washer 284 while a spherical washer 286 is provided axially between the conical race 285 and the main shaft assembly 180. In one aspect, the spherical washer 286 avoids edge loading of the thrust mechanism due to shaft misalignment and also maintains a line contact between them to minimize frictional losses. A wave spring 287, located axially between the thrust washer 283 and the head set gear 200 is also shown as being provided. The wave spring 287 generates a light axial force against the thrust washer 283 in a direction towards the spherical washer 286. The thrust mechanism also includes a bearing 288 (e.g. a needle roller bearing) located radially between the conical race 285 and the input shaft 172. The bearing 288 enables for rotation of the rollers 282, thrust washer 284, and conical race 285 about the input shaft 172. The bearing 288 also maintains differential speed in between the input shaft 172 and the thrust mechanism 280. In one aspect, the conical race 285 has an L-shape in cross-section with a radial extension portion 285a and an axial extension portion 285b, wherein the radial extension portion 285a is located radially between the bearing 288 one on side and the thrust rollers 282 and thrust washer 284 on the other side, and wherein the axial extension portion 285b is located axially between the thrust washer 284 and the spherical washer 286. In one aspect, the axial extension portion 285b and the spherical washer 286 have contacting surface that extend at an oblique angle to longitudinal axis or axis of rotation of the thrust mechanism 280 while the spherical washer 286 and main shaft assembly 180 have contacting surfaces that extend orthogonally from the rotational axis.

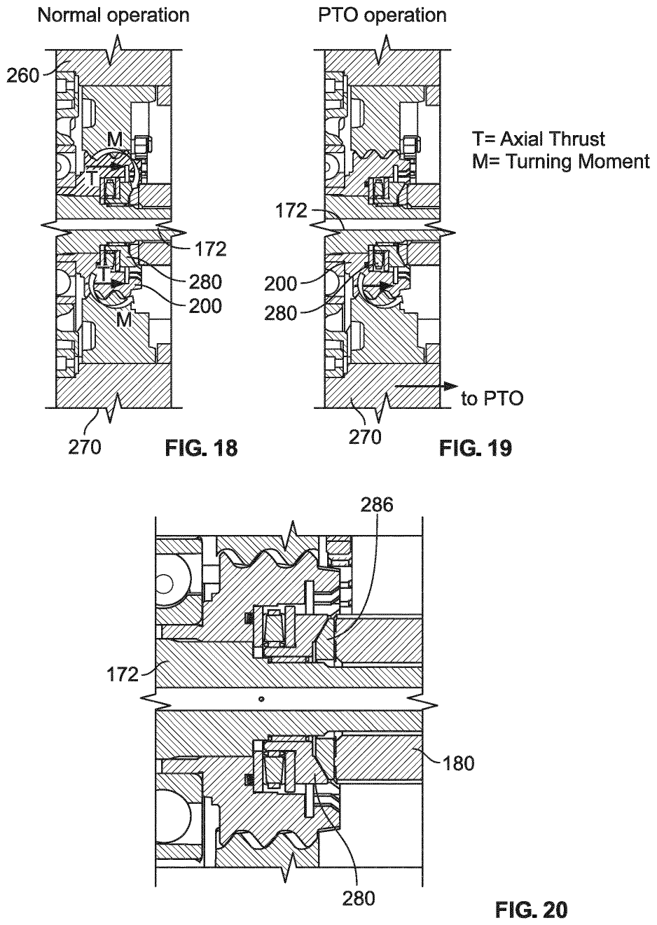

With reference to FIGS. 18 and 19, a normal output operation and a PTO output operation are respectively shown. During normal operation, the moment forces generated from the counter shafts 260, 270 are equal and offsetting, and thus no net moment force is generated at input head set drive gear 200 and the input shaft 172. However, during PTO operation, a single countershaft 270 is loaded which generates a turning moment on input head set drive gear 200 due to unbalanced axial thrust force at single mesh point. The thrust mechanism 280 advantageously prevents overturning of head set drive gear 200 in the PTO operational mode, and thus reduces mesh misalignment which helps enhancing gear reliability.

With reference to FIG. 20, it is illustrated that the spherical washer 286 of the thrust mechanism 280 provides a resting or abutment surface for the main shaft assembly 180. This arrangement provides for easier assembly.

### First Sliding Clutch Assembly

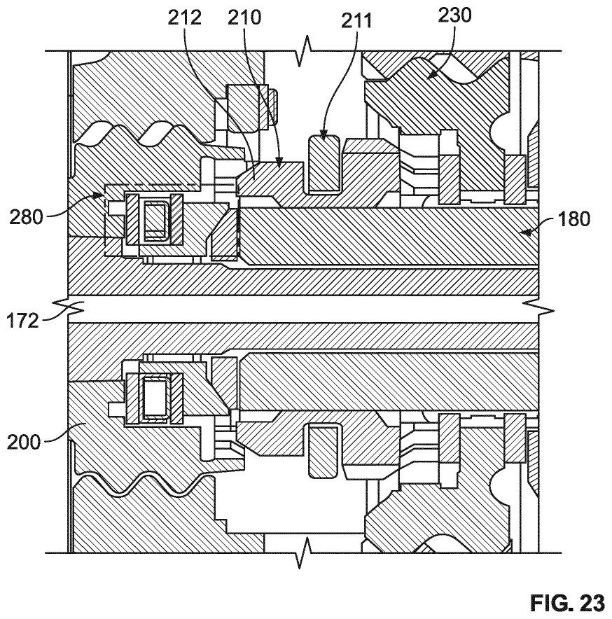

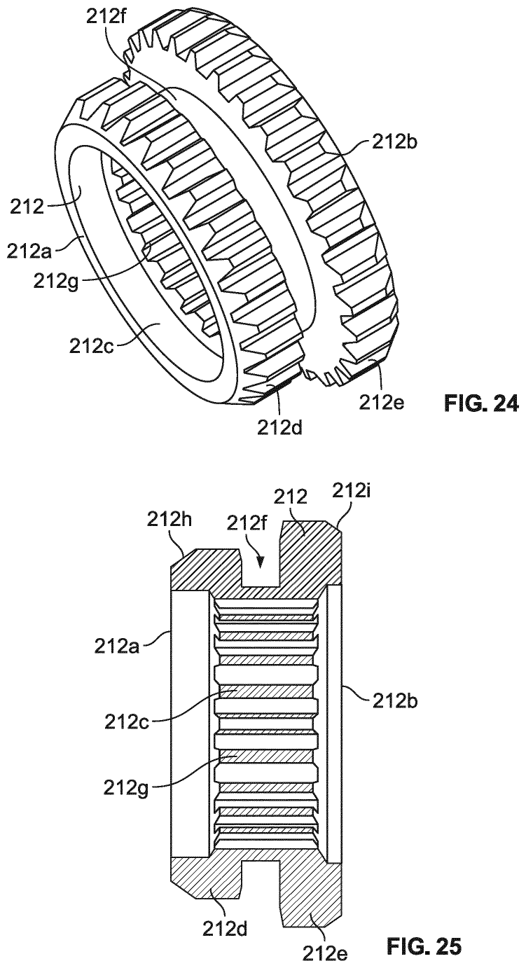

Referring to FIGS. 23-24, aspects of the sliding clutch assembly 210 are now described in more detail.

In electric vehicle motors, power and torque characteristics curves mandate very high, low gear utilization thus posing challenge to the reliability of lower gears. The design of deep HS gear reduction ratio (Layer 1) will balance the damage accumulation in layer 4 and will ensure the reliability targets are met. But this deep ratio design of Layer 1 within the given space (designed CD) reduces gear root diameters of the head set drive gear on the input shaft. This limits the maximum diameter of underlying splines of gears and mating sliding sleeves. At the same time, high motor speeds (e.g 5000 RPM) requires higher thrust area for effective gear PV and stronger spline on the Layer 2 (due to higher gear step) driving the high diameter requirements. The conventional symmetrical sleeve design will not be able to meet these contradictory retirements, hence the disclosed asymmetrical sleeve design is presented to meet these requirements. The disclosed clutch assembly 210 ensures full spline engagement at both gears and main shafts in both aft and fore conditions to keep the spline stresses under limits and also avoid the tipping or misalignment of the sleeve over the main shaft under loaded conditions, especially under the PTO conditions. Along with an asymmetrical design, the disclosed clutch assembly 210 has an optimized spline at the main shaft sleeve interface to aid in maximizing the thrust areas (reducing the deflection and PV values) and radial clearances (reducing wear and temperature) between yoke and sleeve.

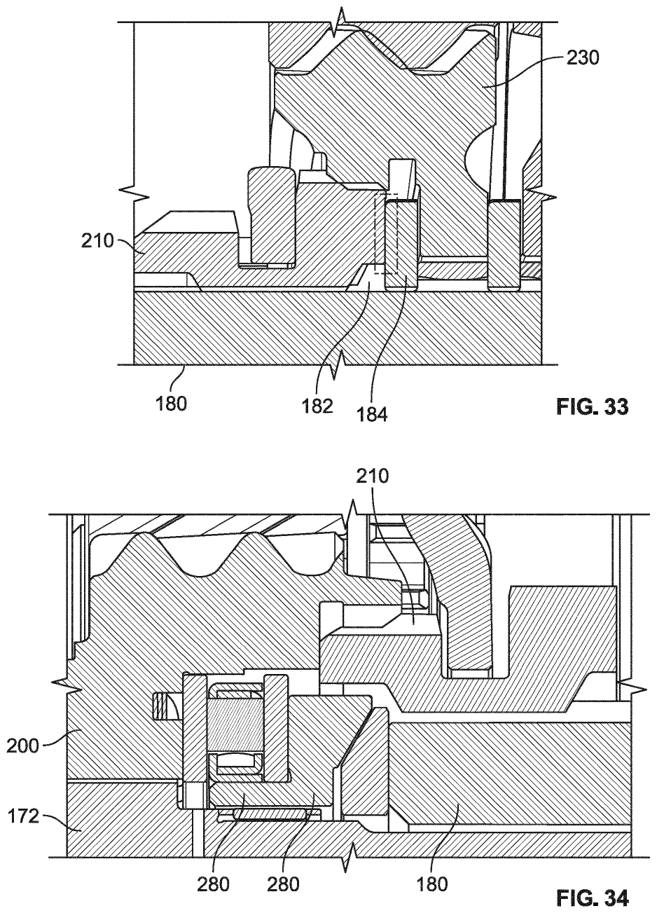

In one aspect, the clutch assembly 210 includes a shift yoke 211 that is a part of the shift shaft assembly 135 and a sleeve member 212 whose position is controlled by the shift shaft assembly 135. As described briefly above, the clutch member can be operated to ground the head set gear 200 to the main shaft assembly 180 or to ground the gear 230 to the main shaft assembly 180. The sleeve member 212 can also be operated into a neutral position between the gears 200, 230. As shown, the sleeve member 212 is an annular body extending between a first end 212a and a second end 212b and defining a central opening 212c through which the main shaft assembly 180 extends. In one aspect, the second end 212 defines a thrust area for an internal washer. As shown, the sleeve member 212 defines a first external gear spline 212d with a plurality of longitudinal splines or teeth, proximate the first end 212a, and also defines a spaced apart second external gear spline 212e with a plurality of longitudinal splines or teeth, proximate the second end 212b. The first external gear spline 212d can be characterized as the fourth gear side, which engages corresponding internally facing teeth or splines of the head set gear 200, while the second external gear spline 212e can be characterized as the third gear side, which engages with corresponding internally facing teeth or splines of the drive gear 230. A channel 212f is formed between the external gear spline 212d, 212e which serves as a contact area for the shift yoke 211. The sleeve member 212 further defines an internal interface 212g including a plurality of longitudinal splines or teeth. The internal interface 212g meshes with corresponding splines or teeth 182 on the main shaft assembly 180 (see FIG. 33) such that the sleeve member 212 can be slid axially along the length of the main shaft assembly 180 while still being able to transmit a torque force from the external gear splines 212d, 212e to the main shaft assembly 180. Thrust washers 182 may also be provided about the main shaft assembly 180. In the example shown at FIG. 33, a thrust washer 184 is provided that provides an axial stop for the gear 230 and for the sleeve member 212. The thrust washer 184 is shown in isolation at FIG. 29. To facilitate entry of the sleeve 212 into the interiors of the head set gear 200 and drive gear 230, the respective ends 212h, 212i of the external gear spline 212d, 212e can be provided with a tapered or chamfered region.

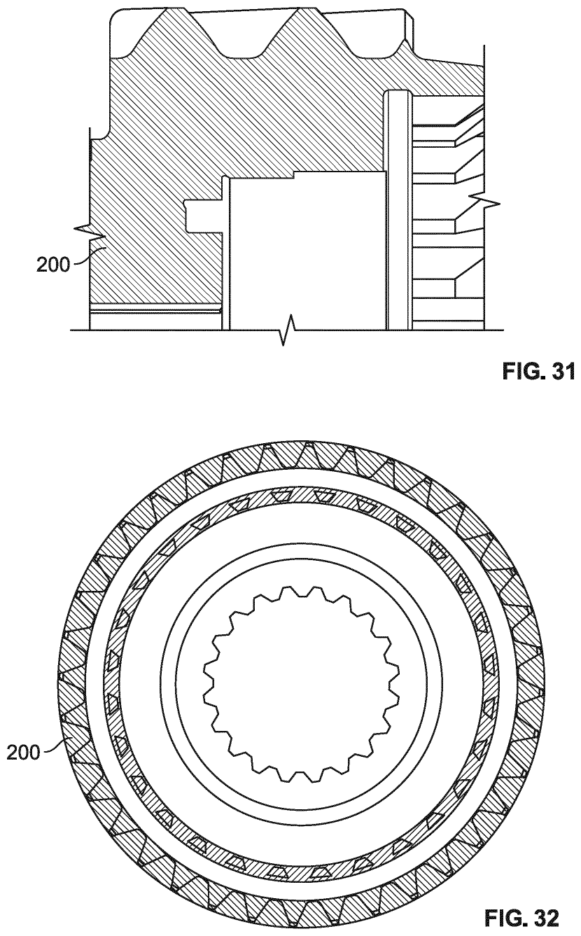

With continued reference to FIGS. 31 and 32, aspects and dimensions of the head set gear 200 are shown. In one aspect, a deep head set gear ratio drives a root diameter of the head set gear 200 to (114.7 mm). Accordingly, the head set gear 200 is configured with a minimized internal spline maximum diameter (104.44 mm) to ensure sufficient web thickness (4.5 mm) on the head set gear 200. This configuration aids in meeting the spline strength requirements at the head set gear 200 and sleeve member 212 while still being able to package the assembly within given space between the head set gear 200 and main shaft assembly 180. With reference to FIGS. 26 to 29, the internal splines on the head set gear 200 should also be designed to maximize the internal spline minimum diameter (68.5 mm) of the internal interface 212g, configured as splines 212g, of the clutch member 200 to ensure sufficient spline height (2.63 mm) and maximum possible overlap area between the yoke 211 and sleeve member 212. This configuration reduces yoke deflections and PV values, and thus increases reliability. This maximization further aids in increasing the diameter of the yoke slot 212f (80.1 mm) in the sleeve member 212 and the diametrical cross-sectional thickness of sleeve to 6.36 mm while still attaining the clearances between the yoke 211 and sleeve member 212.

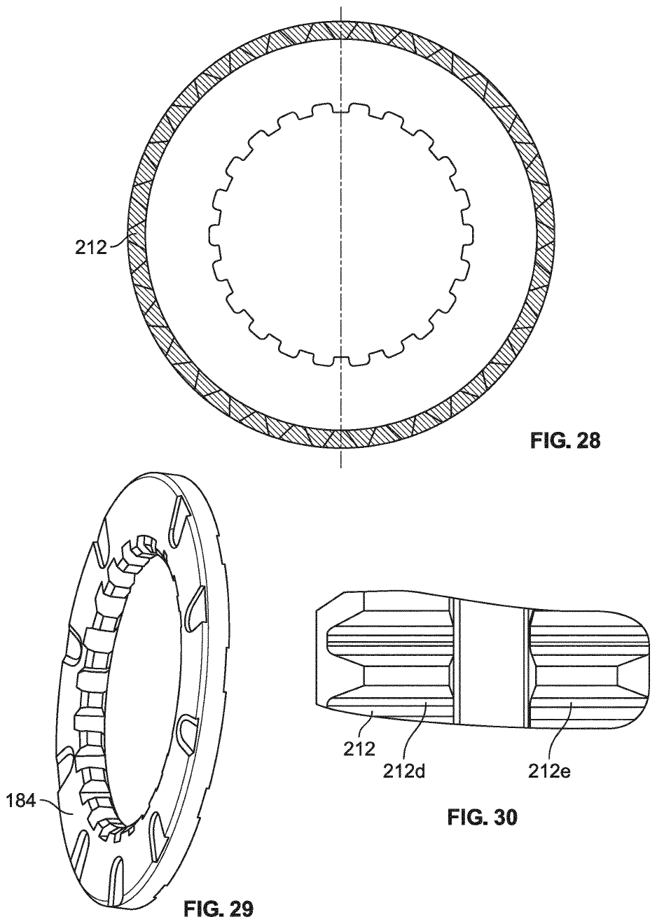

With reference to FIGS. 28, 29, and 34, it is noted that as electric vehicle motors spin at more than 5000 RPM (almost twice the speed of conventional engines) at very high speed, PV and thrust area of the sleeve member 212 represents a critical parameter in designs, especially for third gear. If the thrust washer diameter is increased without a corresponding change in spline diameter, the washer would interfere. As such, spline diameter at the second end 212b of the sleeve member 212 would define the maximum washer that can be accommodated in this architecture. To maximize the thrust area and diameter of thrust washer 184 between the shaft assembly 180 and gear 230, the asymmetrical sleeve member 212 is designed with a maximized external spline minor diameter (109.6 mm) on the third gear side (external gear spline 212e). This allows to maximize the thrust washer 184 diameter to 107 mm and thus reduces the PV effectively between washer 184 and the gear 230. This design also helps to maximize the overlap area between the yoke 211 and sleeve member 212 and reduced PV between yoke 211 and sleeve member 212 as well.

In one aspect, the splines 212d, 212e of the sleeve member 212 have been designed and optimized to ensure smooth torque transfer and gear shifting in third and fourth gear. For example, the spline sections 212d, 212e ensure the required shifting forces in third and fourth force gears are lower than the XY shifter shift forces (240 lbs) in all possible conditions, as illustrated in Table 1 below.

TABLE 1

Shift Force (N)

| Grade | 4^{th} Gear | 3^{rd} Gear | 2^{nd} Gear | 1^{st} Gear |
|---|---|---|---|---|
| 3% | 26.73 | 48.29 | 31.25 | 64.27 |
| 8% | 29.92 | 58.21 | 42.00 | 97.71 |
| 10% | 31.19 | 62.14 | 46.26 | 110.98 |
| 15% | 34.33 | 71.87 | 56.81 | 143.79 |
| 20% | 37.40 | 81.39 | 67.12 | 175.89 |
| 25% | 40.38 | 90.64 | 77.14 | 207.08 |
| 30% | 43.26 | 99.57 | 86.82 | 237.19 |

With reference to FIG. 30, the splines 212d, 212e of the sleeve member 212 are provided with a back taper angle of 2.82° to avoid gear jump out while ensuring that disengagement forces are not excessively high and can be easily achieved, as illustrated in Table 2 below which shows the calculated pull out force using such a back taper angle.

TABLE 2

| | Uphill condition | | | | Downhill condition | | | |
|---|---|---|---|---|---|---|---|---|
| | 1st | 2nd | 3rd | 4th | 1st | 2nd | 3rd | 4th |
| | Gear | Gear | Gear | Gear | Gear | Gear | Gear | Gear |
| Fork force | 177.49 | 54.89 | 41.02 | 21.24 | 169.25 | 52.78 | 31.92 | 16.32 |
| required | | | | | | | | |
| (lbf) - | | | | | | | | |
| cold temp. | | | | | | | | |
| Fork force | 143.51 | 49.83 | 36.09 | 16.75 | 135.12 | 41.10 | 34.29 | 15.98 |
| required | | | | | | | | |
| (lbf) - | | | | | | | | |
| normal | | | | | | | | |
| temp. | | | | | | | | |

With reference to FIG. 34, the sleeve member 212 design is also such that sufficient clearance with thrust elements under the head set gear 200, even when it is in engaged condition, are ensured. The disclosed design also ensures 100% spline engagement, thus avoiding the tip off the sleeve around main shaft assembly 180 in the fourth gear engaged condition.

### Enclosure Sealing

With reference to FIG. 43, aspects of the enclosure relating to sealing are shown in further detail. As shown, a gasket 164 is provided to prevent sealing between the adapter housing 160 and shallow main case 150 while an anaerobic sealing joint 158 is provided between the shallow main case 150 and rear enclosure part 102. A gasket 112 is also shown as being provided between the rear enclosure part 102 and rear bearing cover 370. Sealing joints 380a, 390a are also provided for cover assemblies 380, 390, respectively.

Other implementations will be apparent to those skilled in the art from consideration of the specification and practice of the examples and teachings presented herein. It is intended that the specification and examples be considered as exemplary only, with the true scope of the invention being indicated by the following claims.

1-10. (canceled)

11. A transmission assembly comprising:
a) an input shaft assembly including an input shaft extending between a first end and a second end;
b) an output shaft assembly including an output shaft;
c) a power train gear assembly including at least one mechanism for changing a gear ratio between the input shaft assembly and the output shaft assembly, wherein the power train gear assembly includes a head set gear connected directly to the input shaft proximate the first end; and
d) a bearing assembly including a first bearing assembly supporting the head set gear and a second bearing assembly supporting the input shaft proximate the second end, wherein the second bearing assembly and the second end of the input shaft are located within an internal cavity of the output shaft.

12. The transmission assembly of claim 11, wherein the head set gear has a first connection interface and a second connection interface with the input shaft.

13. The transmission assembly of claim 12, wherein the first connection interface is a splined connection and the second connection interface is a press fit interface.

14. The transmission assembly of claim 11, wherein the first bearing assembly is press fit onto the head set gear.

15. The transmission assembly of claim 11, further comprising:
a) a thrust mechanism for neutralizing opposing axial loads generated between the input shaft and a main shaft.

16. The transmission assembly of claim 15, further comprising:
a) a main shaft partially surrounding and coaxially aligned with the input shaft, wherein the thrust mechanism is located between an axial end of the main shaft and an axial surface of one or both of the head set gear and the input shaft.

17. The transmission assembly of claim 15, wherein the thrust mechanism is supported by one or both of the head set gear and the input shaft.

18. The transmission assembly of claim 15, wherein the thrust mechanism is located axially between the first bearing assembly and the second bearing assembly.

19. The transmission assembly of claim 15, wherein the thrust mechanism is at least partially disposed in a cavity formed between the head set gear and the input shaft.

20. The transmission assembly of claim 11, further comprising a power take-off (PTO) unit.

21. A transmission assembly comprising:
a) an input shaft assembly including an input shaft extending between a first end and a second end;
b) an output shaft assembly including an output shaft;
c) a power train gear assembly including at least one mechanism for changing a gear ratio between the input shaft assembly and the output shaft assembly, wherein the power train gear assembly includes a head set gear connected directly to the input shaft proximate the first end; and
d) a thrust mechanism for neutralizing opposing axial loads generated between the input shaft and a main shaft.

22. The transmission assembly of claim 21, wherein the thrust mechanism is supported by one or both of the head set gear and the input shaft.

23. The transmission assembly of claim 21, wherein the thrust mechanism is located axially between a first bearing assembly and a second bearing assembly supporting the input shaft.

24. The transmission assembly of claim 21, wherein the thrust mechanism is at least partially disposed in a cavity formed between the head set gear and the input shaft.

25. (canceled)

26. The transmission assembly of claim 21, wherein the thrust mechanism includes a plurality of cylindrical rollers disposed between a pair of thrust washers.

27. The transmission assembly of claim 21, wherein the thrust mechanism includes a bearing located about the input shaft.

28. (canceled)

29. (canceled)

30. (canceled)

31. A transmission assembly comprising:
a) an input shaft assembly including an input shaft extending between a first end and a second end;
b) an output shaft assembly including an output shaft; and
c) a geartrain assembly for changing a gear ratio between the input shaft and the output shaft, the geartrain assembly including:
i) a head set gear fixed to the input shaft, the head set gear being intermeshed with a first countershaft gear and defining a first internal drive interface;
ii) a drive gear intermeshed with a second countershaft gear and defining a second internal drive interface;
iii) a main shaft intermeshed with the output shaft, the main shaft defining a first external drive interface; and
iv) a clutch assembly including a sleeve member slidably disposed about the main shaft, the sleeve member defining a third internal drive interface engaged with the first external drive interface, the sleeve member defining a first external gear spline for engagement with the first internal drive interface and a second external gear spline for engagement with the second internal drive interface, wherein the first external gear spline has a first diameter and the second external gear spline has a second diameter different from the first diameter.

32. The transmission assembly of claim 31, wherein the first diameter is smaller than the second diameter.

33. The transmission assembly of claim 31, wherein the first external gear spline is spaced from the second external gear spline so as to form a channel for accepting a shift yoke.

34. The transmission assembly of claim 31, wherein first external gear spline is at least partially received within the head set gear when the sleeve member is in a first position.

35-40. (canceled)
